(19) United States
(12) Patent Application Publication
(10) Pub. No.: US 2006/0101461 A1
(43) Pub. Date: May 11, 2006

(54) Apparatus and method for installing monitor driver

(75) Inventor: Chang Woo Han, Gumi-si (KR)

Correspondence Address: FLESHNER & KIM, LLP, P.O. BOX 221200, CHANTILLY, VA, 20153, US

(73) Assignee: LG Electronics Inc.

(21) Appl. No.: 11/166,182

(22) Filed: Jun. 27, 2005

(30) Foreign Application Priority Data
Oct. 19, 2004 (KR) 10-2004-0083587

(51) Int. Cl. G06F 9/44

(52) U.S. Cl. 717/174; 719/327

(57) ABSTRACT

Apparatus and methods directed to installing a monitor driver are disclosed. An embodiment of a method can include sending a request signal from a computer to a monitor to request sending of at least one driver file stored in the monitor, sending the driver file stored in the monitor to the computer in response to the request signal, and installing the sent driver file in the computer. A monitor driver can be installed without user action or selection.

This application claims the benefit of Korean Patent Application No. 2004-083587, filed on Oct. 19, 2004, which is hereby incorporated by reference as if fully set forth herein.

### BACKGROUND OF THE INVENTION

1. Field of the Invention

The present invention relates to an apparatus and method for installing a monitor driver.

2. Background of the Related Art

Generally, when a display device such as a monitor is purchased by a user, it is provided to the user along with a monitor driver in the form of a compact disc (CD). The monitor driver includes a basic install program for installation of the driver, and files (e.g., *.INF, *.ICM, . . . ) associated with displayable resolutions, color characteristic information, etc. of the monitor.

When the user inserts the monitor driver CD in a CD-ROM drive of a computer and runs the install program included in the driver CD to install the monitor driver, an install menu is displayed on the screen of the monitor. Then, if the install menu is selected by the user, the computer displays a list of monitor model names included in the monitor driver CD on the monitor screen. When the user selects the model name of his/her own monitor from among the list of monitor model names displayed on the monitor screen, the computer reads at least one driver file corresponding to the monitor model name selected by the user from the monitor driver CD and executes the driver installation based on the read driver file.

The computer is adapted to provide a video signal to the monitor. In order to supply an optimum video signal to the monitor, the computer has to accurately recognize the color characteristics of the monitor through the driver file. When the driver installation is not performed, the monitor cannot carry out a display optimal to the color characteristics of the monitor, although it is not unable to perform the basic display itself. For this reason, the user must install the monitor driver so that the monitor purchased by him/her can act to the best of its capability.

As described above, however, the related art has various disadvantages. For example, in the related art driver installation method, the user has the trouble of having to insert the monitor driver CD, select the install menu, and check the displayed monitor model names one by one to identify and select the model name of his/her own monitor. Further, errors in identification can be made during the installation.

The above references are incorporated by reference herein where appropriate for appropriate teachings of additional or alternative details, features and/or technical background.

### SUMMARY OF THE INVENTION

An object of the invention is to solve at least the above problems and/or disadvantages and to provide at least the advantages described hereinafter.

Another object of the present invention is to provide an apparatus and a method for installing a monitor driver that substantially obviates one or more problems caused by limitations and disadvantages of the related art.

Another object of the present invention is to provide an apparatus and method for directly installing a monitor driver.

To achieve at least these objects and other advantages in a whole or in part and in accordance with the purpose of the invention, as embodied and broadly described herein, a method for installing a monitor driver can include sending a request signal from a computer to a monitor to request sending of at least one driver file stored in the monitor, sending the driver file stored in the monitor to the computer in response to the request signal, and installing the sent driver file in the computer.

According to one aspect of an embodiment of the invention, sending the request signal from the computer to the monitor can include running an install program stored in a storage unit (e.g., external) and generating the request signal according to the install program.

In another aspect of the present invention, a method for installing a monitor driver can include sending a request signal from a computer to a monitor requesting monitor information stored in the monitor, sending the monitor information stored in the monitor to the computer in response to the request signal, and installing a driver file for the monitor stored in an external storage unit in the computer on the basis of the sent monitor information.

According to a further aspect of the present invention, an apparatus for installing a monitor driver can include a monitor configured to store at least one driver file and output the stored driver file in response to a request signal that requests sending of the stored driver file, a computer configured to send the request signal to the monitor and install the driver file received from the monitor in response to the request signal, and a storage unit configured to store an install program for installation of the driver file.

According to one aspect of an embodiment, the monitor can include a memory configured to store the driver file and a controller configured to send the driver file stored in the memory to the computer in response to the request signal.

According to another aspect of the present invention, an apparatus for installing a monitor driver can include a monitor configured to output monitor information prestored therein in response to a request signal that requests sending of the prestored monitor information, a storage unit configured to store at least one driver file for driving of the monitor, and a computer configured to install the driver file stored in the storage unit on the basis of the sent prestored monitor information from the monitor.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 is a block diagram showing the configuration of a monitor driver installation apparatus according to embodiments of the invention;

FIG. 2 is a flow chart illustrating an embodiment of a monitor driver installation method according to the invention; and

FIG. 3 is a flow chart illustrating another embodiment of a monitor driver installation method according to the invention.

### DETAILED DESCRIPTION OF PREFERRED EMBODIMENTS

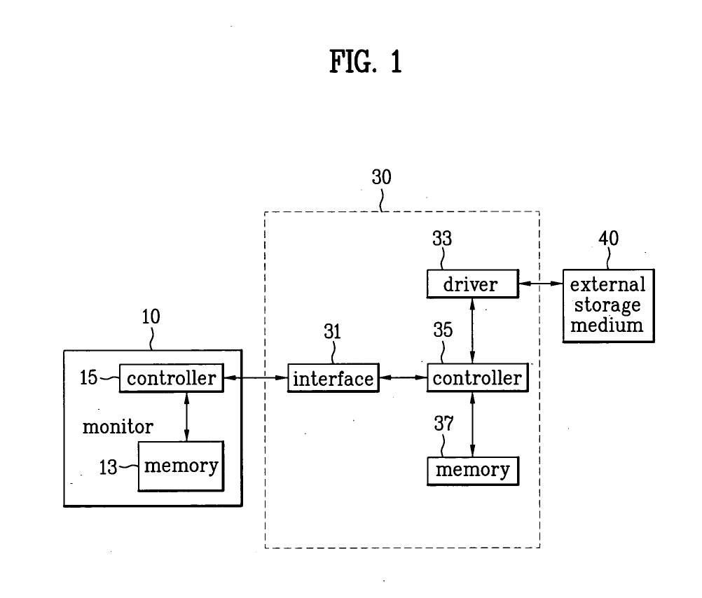

FIG. 1 is a block diagram showing a configuration of a first embodiment of a monitor driver installation apparatus according to the invention. As shown in FIG. 1, the first embodiment of the monitor driver installation apparatus according to the invention can include a monitor 10, a computer 30, and an external storage medium 40.

The monitor 10 can include a memory 13 and a controller 15. The memory 13 can store at least one driver file for driving of the monitor 10. The controller 15 can send the driver file stored in the memory 13 to the computer 30 in response to a request signal from the computer 30. The request signal from the computer 30 can be a signal that requests the monitor 10 to send the driver file stored in the memory 13 to the computer 30.

The computer 30 can include a drive 33, an interface 31, a memory 37, and a controller 35. The drive 33 may be any one of a CD drive, a floppy disk drive, a card slot, a universal serial bus (USB) port, and a digital versatile disc (DVD) drive or the like. The interface 31 may be a graphic card or the like. The graphic card can be coupled with the monitor 10 via a communication cable, or video cable, of an analog or digital type capable of communicating over a display data channel (DDC). The video cable may be based on any one of a D-SUB protocol, a digital video interface (DVI) protocol, and a high definition multimedia interface (HDMI) protocol (e.g., standardized HDMI protocol). The memory 37 can be a storage area for installing the driver file sent from the monitor 10. The controller 35 can execute an install program in the external storage medium 40 to request the monitor 10 to send the driver file, and install the driver file that was sent from the monitor 10 in response to the request, in the memory 37.

The external storage medium 40 may be any type of removable storage medium, such as a CD, a floppy disk, a memory card, a USB memory stick, a DVD, or the like. The external storage medium 40 can include the install program, which is preferably automatically run at the time that the medium 40 is inserted in the drive 33 of the computer 30, to advance a driver installation process.

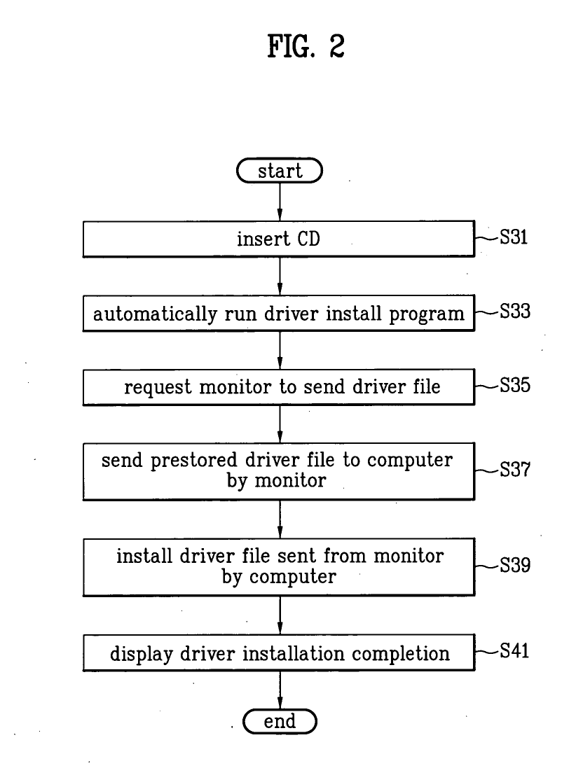

A monitor driver installation method according to a first embodiment of the invention will now be described with reference to FIG. 2. As shown in FIG. 2, the first embodiment of a monitor driver installation method can be applied to and will be described using the first embodiment of the monitor driver installation apparatus shown in FIG. 1. Moreover, the invention is not intended to be so limited.

As shown in FIG. 2, after a process starts, the user can insert the external storage medium (for example, a CD) 40, provided to him/her when purchasing the monitor 10, in the drive 33 of the computer 30 (block S31). Then, the controller 35 of the computer 30 can recognize the CD inserted in the drive 33 and automatically run an install program included in the CD according to an automatic execution file included in the CD (block S33). The install program can contain a variety of commands for allowing the computer 30 to automatically execute the driver installation without user intervention.

The controller 35 of the computer 30 can advance the driver installation by performing operations based on the commands contained in the install program in a predetermined order. First, using DDC communication, the controller 35 of the computer 30 can request the monitor 10 to send the driver file (block S35).

The controller 15 of the monitor 10 can recognize the driver file sending request and then send the driver file stored in the memory 13 to the computer 30 (block S37). After that, the controller 35 of the computer 30 can store the driver file sent from the monitor 10 in the corresponding storage area of the memory 37, carry out a registry setting operation and then advance the driver installation (block S39). At this time, the controller 35 of the computer 30 can display the advancing installation states (e.g., blocks S33 to S39) on the screen of the monitor 10. That is, the controller 35 can display text, such as “MONITOR DRIVER INSTALLATION START” and “MONITOR DRIVER INSTALLATION IN PROGRESS (%)”, on the screen to inform the user of the installation advanced state.

When the driver installation is completed, the controller 35 of the computer 30 can display the driver installation completion on the screen (block S41) and automatically perform an operation, such as system rebooting, if necessary.

As described above, the monitor 10 can contain an application or a program for performing the process of recognizing the driver file sending request through the communication with the computer 30 and then sending the driver file contained in the monitor 10. From block S41, the process can end.

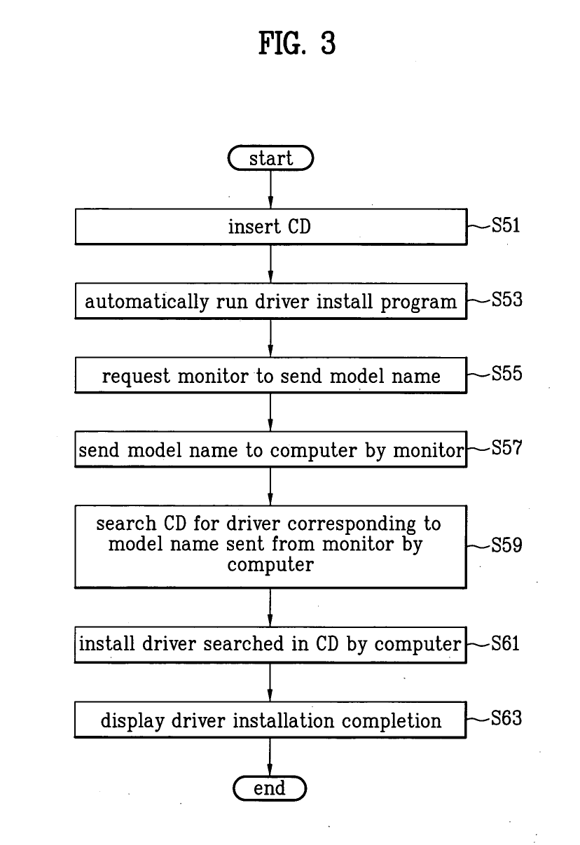

A monitor driver installation apparatus and method according to a second embodiment of the invention will now be described with reference to FIG. 3. The second embodiment of the driver installation apparatus according to the invention can have the same configuration as that according to the first embodiment of the driver installation apparatus, with the exception that programs for operating the respective controllers of the monitor 10 and computer 30, information stored in the memories, and information stored in the external storage medium are different from those in the first embodiment.

Thus, the driver installation apparatus according to the second embodiment of the present invention can include the external storage medium 40, the monitor 10, and the computer 30. According to the second embodiment, the monitor 10 can include the memory 13 and the controller 15 where the memory 13 can store monitor information, e.g., the manufacturer name of the monitor, and the identification (ID) or model name of the monitor. According to the second embodiment, the controller 15 can send the monitor information stored in the memory 13 to the computer 30 in response to the computer's request.

According to the second embodiment, the computer 30 can include the drive 33, the interface 31, the memory 37, and the controller 35. The drive 33 may be any one of a CD drive, a floppy disk drive, a card slot, a USB port, and a DVD drive. The interface 31 may be a graphic card, which is connected with the monitor 10 via a communication cable, or video cable, of an analog or digital type capable of communicating over a DDC. The video cable may be based on any one of a D-SUB protocol, a DVI protocol, and an HDMI protocol. According to the second embodiment, the memory 37 can have a storage area for storing the monitor information sent from the monitor 10 and installing at least one driver file corresponding to the monitor information. According to the second embodiment, the controller 35 can run an install program in the external storage medium 40 to request the monitor 10 to send the monitor information, read (e.g., from the external storage medium 40) a driver corresponding to a monitor ID or model name contained in the monitor information, which was sent from the monitor 10 in response to the request, and install the read driver in the memory 37.

The external storage medium 40 may be any type of removable storage medium, such as a CD, a floppy disk, a memory card, a USB memory stick, a DVD, or the like. The external storage medium 40 can include monitor drivers of respective models, and the install program, which can be directly or automatically run at the time that the medium 40 is inserted in the drive 33 of the computer 30, to advance a driver installation process.

The monitor driver installation method according to the second embodiment of the invention will now be described with reference to FIG. 3. As shown in FIG. 3, the second embodiment of a monitor driver installation method can be applied to and will be described using the second embodiment of the monitor driver installation apparatus shown in FIG. 1. However, the invention is not intended to be so limited.

As shown in FIG. 3, first, the user can insert the external storage medium (for example, a CD) 40, provided to him/her when purchasing the monitor 10, in the drive 33 of the computer 30 (block S51). Then, the controller 35 of the computer 30 can recognize the CD inserted in the drive 33 and directly or automatically run an install program included in the CD according to an automatic execution file included in the CD (block S53). The install program can contain a variety of commands for allowing the computer 30 to automatically or immediately execute the driver installation even without user intervention.

The controller 35 of the computer 30 can advance the driver installation by performing operations based on the commands contained in the install program in a predetermined order. First, using DDC communication, the controller 35 of the computer 30 can request the monitor 10 to send the monitor information (block S55).

The controller 15 of the monitor 10 can recognize the monitor information sending request and then send the monitor information stored in the memory 13 to the computer 30 (block S57). The monitor information can be stored in the memory 13 (e.g., in a manufacturing process) of the monitor 10.

The controller 35 of the computer 30 can receive the monitor information sent from the monitor 10 and then search the external storage medium 40 for at least one driver file corresponding to the ID or model name of the monitor 10 contained in the received monitor information (block S59).

Thereafter, the controller 35 of the computer 30 can store the searched driver file (e.g., corresponding) in the storage area of the memory 37, carry out a registry setting operation and then perform or advance the driver installation (block S61). At this time, the controller 35 of the computer 30 can display one or more in series of the advanced installation states (e.g., blocks S53 tQ S61) on the screen of the monitor 10. That is, the controller 35 can display text, such as “MONITOR DRIVER INSTALLATION START” and “MONITOR DRIVER INSTALLATION IN PROGRESS (%)” or the like, on the screen to inform the user of the installation advanced state.

If the driver installation is completed, the controller 35 of the computer 30 can display the driver installation completion on the screen (block S63) and immediately or automatically (e.g., without user action) perform an operation, such as system rebooting, if necessary.

The monitor 10 can contain a program for performing at least operations of recognizing the monitor information sending request through the communication with the computer 30 and sending the monitor information contained in the monitor 10. From block S63, the process can end.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments. Furthermore, for ease of understanding, certain method procedures may have been delineated as separate procedures; however, these separately delineated procedures should not be construed as necessarily order dependent in their performance. That is, some procedures may be able to be performed in an alternative ordering, simultaneously, etc.

As described above, embodiments of the invention have various advantages. For example, embodiments of the invention can provide an apparatus and method for installing a monitor driver where the monitor driver can be installed in a computer using at least one driver file stored in a monitor or on the basis of monitor information provided from the monitor. The monitor driver can be installed even without user action such as selection of a monitor type or monitor driver. Therefore, the monitor driver can be automatically installed even without the user's manual setting or operation. In addition, errors etc. that may occur in the user's manual installation process can be reduced or avoided.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A method for installing a monitor driver, comprising:
sending a request signal from a computer to a monitor to request sending of at least one driver file stored in the monitor;
sending the driver file stored in the monitor to the computer in response to the request signal; and
installing the sent driver file in the computer.

2. The method of claim 1, wherein the sending the request signal from the computer to the monitor comprises:
running an install program stored in an external storage unit; and
generating the request signal according to the install program.

3. The method of claim 2, wherein the external storage unit is a compact disc (CD), a floppy disk, a memory card, a universal serial bus (USB) memory stick or a digital versatile disc (DVD).

4. The method of claim 2, wherein the driver file for the monitor is installed responsive to an initial connection of the monitor to the computer.

5. An apparatus for installing a monitor driver, comprising:
a monitor configured to store at least one driver file and output the stored driver file in response to a request signal that requests sending of the stored driver file;
a computer configured to send the request signal to the monitor and install the driver file received from the monitor in response to the request signal; and
a storage unit configured to store an install program for installation of the driver file.

6. The apparatus of claim 5, wherein the monitor comprises:
a memory configured to store the driver file; and
a controller configured to send the driver file stored in the memory to the computer in response to the request signal.

7. The apparatus of claim 5, wherein the storage unit is a CD, a floppy disk, a memory card, a USB memory stick or a DVD.

8. The apparatus of claim 5, wherein the computer comprises:
a drive configured to run the install program stored in the storage unit;
an interface configured to send the request signal to the monitor and receive the driver file from the monitor;
a memory configured to store the received driver file; and
a controller configured to install the driver file according to the install program.

9. The apparatus of claim 8, wherein the computer executes the install program stored in the storage unit to generate the request signal.

10. A method for installing a monitor driver, comprising:
sending a request signal from a computer to a monitor requesting monitor information stored in the monitor;
sending the monitor information stored in the monitor to the computer in response to the request signal; and
installing a driver file for the monitor stored in an external storage unit in the computer on the basis of the sent monitor information.

11. The method of claim 10, wherein the monitor information comprises at least one of a manufacturer name of the monitor, an identification (ID) of the monitor or a model name of the monitor.

12. The method of claim 10, wherein sending the request signal from the computer to the monitor comprises generating the request signal in the computer according to an install program stored in the external storage unit.

13. The method of claim 10, wherein the external storage unit is a CD, a floppy disk, a memory card, a USB memory stick or a DVD.

14. An apparatus for installing a monitor driver, comprising:
a monitor configured to output monitor information prestored therein in response to a request signal that requests sending of the prestored monitor information;
a storage unit configured to store at least one driver file for driving of the monitor; and
a computer configured to install the driver file stored in the storage unit on the basis of the sent prestored monitor information from the monitor.

15. The apparatus of claim 14, wherein the monitor comprises:
a memory configured to store the monitor information; and
a controller configured to send the prestored monitor information stored in the memory to the computer in response to the request signal.

16. The apparatus of claim 14, wherein the storage unit is a CD, a floppy disk, a memory card, a USB memory stick or a DVD.

17. The apparatus of claim 14, wherein the computer comprises:
a drive configured to run an install program stored in the storage unit;
an interface configured to send the request signal to the monitor and receive the monitor information from the monitor;
a memory configured to store the received monitor information; and
a controller configured to install the driver file for the monitor on the basis of the monitor information.

18. The apparatus of claim 17, wherein the computer executes the install program stored in the storage unit to generate the request signal.
